(19) United States
(12) Patent Application Publication
(10) Pub. No.: US 2014/0064334 A1
(43) Pub. Date: Mar. 6, 2014

(54) MEASUREMENT RAKE WITH A TWO PIECE CYLINDRICAL MAST

(71) Applicants: Tonya Lynn Watkins, Troy, NY (US); Paul Dausacker, Saratoga Springs, NY (US); Paul Tangredi, Niskayuna, NY (US); Richard E. Warren, JR., Schenectady, NY (US)

(72) Inventors: Tonya Lynn Watkins, Troy, NY (US); Paul Dausacker, Saratoga Springs, NY (US); Paul Tangredi, Niskayuna, NY (US); Richard E. Warren, JR., Schenectady, NY (US)

(73) Assignee: GENERAL ELECTRIC COMPANY, SCHENECTADY, NY (US)

(21) Appl. No.: 13/604,900

(22) Filed: Sep. 6, 2012

(51) Int. Cl. G01M 15/02; G01K 7/02

(52) U.S. Cl. CPC G01M 15/02; G01K 7/02
USPC 374/179; 73/112.01; 29/428

(57) ABSTRACT

A two piece measurement rake has a first split tubular section with at least one hollow support member disposed therethrough the measurement rake includes at least one sensor probe mounted on the hollow support member and coupled to a transducer. A second split tubular section is attached to the first split tubular section, and forms an interior cavity on which the at least one transducer tube is disposed.

### TECHNICAL FIELD

The subject matter disclosed herein relates generally to instrumentation systems for gas turbines or steam turbines and more particularly relates to an instrumentation rake for measuring pressure, temperatures or both.

### BACKGROUND

Stationery test instrumentation for modern turbine engines measure internal conditions such as pressure and temperature at various stages along the flow path. Air pressure and temperature measurements may be made by through the use of Pitot tubes, Kiel probes thermocouples, and other devices positioned within the flowpath and elsewhere.

Typically, sensors may be disposed at various turbine locations. The sensors may be mounted on rakes attached to a surface within the turbine. A rake is generally a stationary component consisting of multiple sensors distributed along the length of a mast, usually installed radially, to obtain pressure and temperature profile information in the flow path. The sensors will typically have tubing or wires that are coupled to transducers. The tubing and wires are inserted in the mast, and consequently, the mast must have a sufficiently large diameter to enable the insertion (threading) of the tubing and wires. Space for instrumentation in a turbine is very limited. The space limitation within the turbine imposes a number of constraints on conventional rakes. For example, it is difficult to assemble and locate conventional rakes within the turbine. In conventional rakes, pressure tubing and thermocouple wiring have to be threaded through a one piece rake mast and then the Kiel probe heads are brazed or welded to the mast. Thermocouple wiring may be 40-50 ft. long and is carefully calibrated. When the thermocouple wiring is handled there is a chance that the wire may be ‘kinked’ resulting in a change of the calibration. The sensitivity of the thermocouple wiring to kinking makes threading and brazing difficult often resulting in calibration changes. In conventional rakes the pressure tubing requires internal joints for assembly (change in tubing size—joints internal to the rake mast). These joints themselves, introduce the potential for leakage. They are also sensitive to vibration and—even if successfully installed initially—may introduce leakage. Internal leaks (inside the rake mast) are difficult if not impossible to fix. The size of conventional rakes may also affect the precise angular placement and alignment of the sensors thereby limiting the number of radial measurement locations. Additionally, any internal defects to components of conventional rakes are difficult to repair.

### BRIEF DESCRIPTION OF THE INVENTION

In accordance with one exemplary non-limiting embodiment, the invention relates to a measurement rake with a first split tubular section and at least one hollow support member disposed through the first split tubular section. The measurement rake is provided with at least one sensor probe mounted on the hollow support member and coupled to a transducer and a second split tubular section attached to the first split tubular section, and forming an interior cavity on which the at least one transducer tube is disposed.

In another embodiment, a method of assembling an instrumentation rake includes disposing a sensor subassembly having at least sensor lead on an opening on a first split tubular section. The method further includes routing the sensor lead through the opening, attaching the sensor subassembly to the first split tubular section, and attaching a second split tubular section the first split tubular section.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a cross sectional view of an embodiment of a rake subassembly.

FIG. 2 is a longitudinal cross sectional view of an embodiment of a rake subassembly.

FIG. 3 is a front view of an embodiment of a rake.

### DETAILED DESCRIPTION OF THE INVENTION

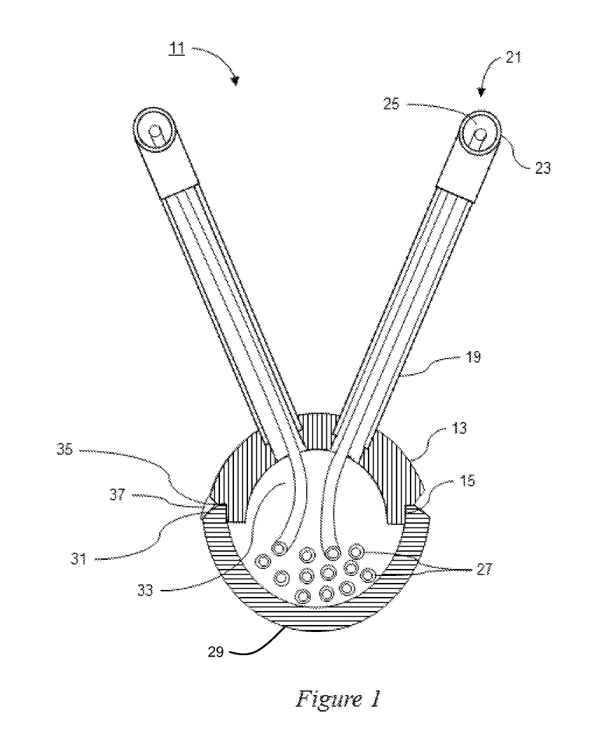

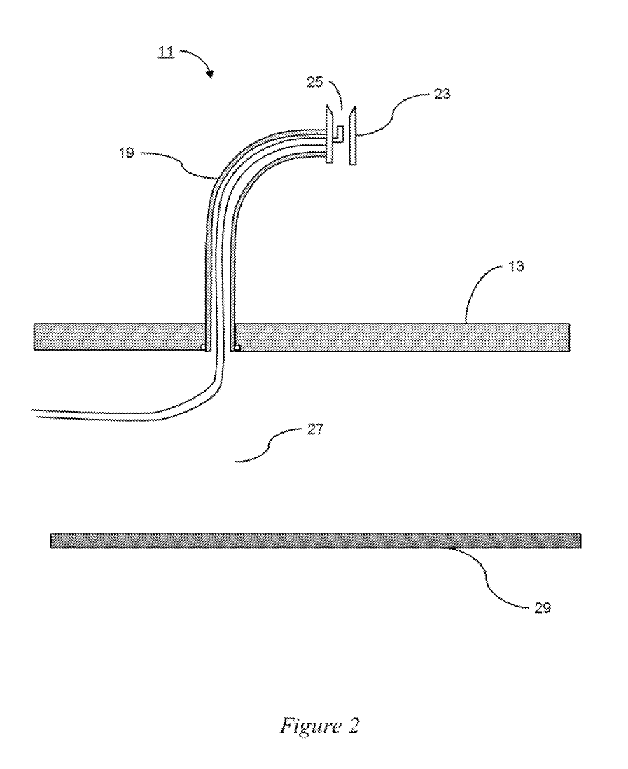

FIGS. 1, 2 and 3 illustrate an example of one embodiment of a rake subassembly 11. The rake subassembly 11 may include a front support member 13 made of steel or other suitable material. The front support member 13 may be in the shape of a longitudinally split tube of a predetermined thickness (split tubular section). The front support member 13 may be provided with a rabbet edge 15 along the longitudinal ends of the split tube. Attached to the front support member is an instrument support 19. The instrument support 19 is preferably made of the material strong enough to support static loading and bending stresses imposed by the flowing fluid. A sensor probe 21 is disposed at the end of the instruments support 19. An example of a sensor probe 21 may include a Kiel probe, such as those manufactured by United Sensor Corporation. A Kiel probe measures total pressure/or temperature of a flowing fluid. The Kiel probe is basically a Pitot tube 25 surrounded by a shroud 23. The Kiel probe is substantially insensitive to changes in yaw angle, and is used when the probe's alignment with the flow direction is variable or imprecise. The sensor probe 21 may also include thermocouples for the measurement of temperature. The sensor probe 21 may be coupled with transducer tube 27 that is in communication with a transducer (not shown). The sensor lead may include wiring for a thermocouple. A rear split tubular cap 29 (second split tubular section) may be disposed adjacent to the front support member 13. The rear split tubular cap 29 may be provided with a beveled edge (weld chamfer) 31 adapted to engage the rabbet edge 15 of the front support member 13 thereby defining a cavity 33. The abutting edges of front support member 13 and rear split tubular cap 29 define a seam 35. The front support member 13 and the rear split tubular cap 29 may be welded (weld 37) along the seam 35. Together the front support member 13 and the rear split tubular cap 29 form a rake mast.

As illustrated in FIG. 1, the front support member 13 may, in one embodiment, be substantially thicker than the rear split tubular cap 29. The material and thickness of the front support member 13 must be of sufficient tensile strength to support torsional stresses imposed upon the instrument support 19 by the flowing fluids. In one embodiment the rear split tubular cap 29 may be of a thinner material since it is not subjected to the stresses imposed on the front support member 13.

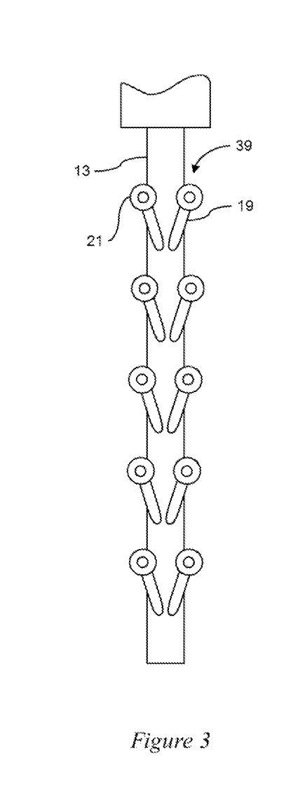

As illustrated in FIG. 3 an embodiment of the rake subassembly 11 may be provided with a plurality of pairs 39 which may comprise a pair of sensor probes 21 each supported by a corresponding instrument support 19 disposed along the length of the front support member 13. The instrument support 19 may be an L-shaped tubular member as illustrated or other shape such as a straight member. The front support member 13 may be attached to a manifold (not shown) that is secured to a surface in the turbine.

The rake subassembly 11 is used to measure total pressures to determine flow profiles. The sensor probe 21 measures the total pressure (stagnation pressure). The stagnation pressure is the value obtained when the fluid flow is decelerated to zero. While the fluid flow passes through the Kiel-style pressure and thermocouple temperature sensors an accurate measurement of the pressure or temperature is recorded at varying radial heights along the rake subassembly 11.

The (two piece) rake subassembly 11 reduces the difficulty of assembly of the sensor probe 21 on the rake subassembly 11. The two-piece construction allows for the transducer tubes 27 and/or thermocouple wires to be assembled on the ‘half’ allowing for careful placement and robust connections. The two piece construction also allows a larger number of measurement elements (sensor probe pairs 39) to be installed on the rake due to easier access and simpler routing. In some embodiments, the size of the rake subassembly 11 may be reduced to an external diameter of 0.75 inches or 0.5 inches.

In one embodiment, the rake subassembly 11 may be assembled inserting the transducer tube 27 through the instrument support 19 and attaching the sensor probe 21 to the instrument support 19 thereby creating a sensor sub assembly. The instrument support 19 of the sensor subassembly then may be attached using conventional metal to metal attachment methods such as brazing, soldering, welding, and the like, to the front support member 13. The instrument support may be permanently attached (braze welded) to the front support member 13. The rear split tubular cap 29 may be welded to the front support member 13 and the weld 37 may be dressed.

The two piece embodiment of the rake subassembly 11 allows instrumentation to be reinforced against vibration by filling the instrument support 19 and/or rake mast 19 with vibration damping material, such as for example epoxy, after assembly to prevent movement of the wires or transducer tubes 27. Additionally the two piece construction of the rake subassembly 11 eliminates joints inside the rake subassembly 11. The only joint is at the probe head, outside the mast—allowing for easy repair of leaks due to poor joint construction. Because of the ease of assembly the rake subassembly 11 makes it easier to attach new instrumentation on rake masts. This instrumentation may include, but is not limited to: Kulites, optical transducers, other electronic instrumentation. Additionally, the two piece embodiment of the rake subassembly allows for the use of anti-vibration devices such as: epoxy, vibrating beam anchored in rake mast to counteract vibration, and the like.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed:

1. A measurement rake comprising:
a first split tubular section;
at least one hollow support member disposed through the first split tubular section;
at least one sensor probe mounted on the at least one hollow support member and coupled to a transducer tube;
a second split tubular section attached to the first split tubular section, and forming an interior cavity on which the transducer tube is disposed.

2. The measurement rake of claim 1 wherein the at least one sensor probe comprises at least one Kiel probe.

3. The measurement rake of claim 2 wherein the at least one Kiel probe comprises a first Kiel probe mounted on the first split tubular section and a second Kiel probe mounted on the first split tubular section and disposed at an angle from the first Kiel probe.

4. The measurement rake of claim 2 wherein the at least one Kiel probe comprises a plurality of Kiel probe pair disposed longitudinally along the first split tubular section, each Kiel probe pair comprising a first Kiel probe mounted on the first split tubular section and a second Kiel probe mounted on the first split tubular section and disposed at an angle from the first Kiel probe.

5. The measurement rake of claim 1 wherein the at least one sensor probe comprises a transducer connected to the transducer tube.

6. The measurement rake of claim 1 wherein the first split tubular section is thicker than the second split tubular section.

7. The measurement rake of claim 6 wherein the first split tubular section comprises a rabbet shaped end portion along a length of the first split tubular section.

8. The measurement rake of claim 7 wherein the second split tubular section comprises a beveled end portion along the length of the second split tubular section.

9. The measurement rake of claim 8 wherein the beveled end portion of the second split tubular section is disposed adjacent to the rabbet shaped end portion of the first split tubular section and wherein the first split tubular section and the second split tubular section define a seam along the length of the first split tubular section and the second split tubular section.

10. The measurement rake of claim 9 wherein the first split tubular section and the second split tubular section are welded along the seam

11. The measurement rake of claim 1 wherein the interior cavity is filled with a vibration damping material.

12. The measurement rake of claim 1 wherein the at least one sensor probe comprises at least one thermocouple.

13. A method of assembling an instrumentation rake comprising:
disposing a sensor subassembly having at least one sensor lead on an opening on a first split tubular section;
routing the at least one sensor lead through the opening;
attaching the sensor subassembly to the first split tubular section; and
attaching a second split tubular section the first split tubular section.

14. The method of claim 13, wherein the sensor subassembly comprises a Kiel sensor, a sensor lead and an instrument support.

15. The method of claim 13 wherein the method element of attaching the sensor subassembly to the first split tubular section comprises welding the sensor subassembly to the first split tubular section.

16. The method of claim 13 wherein the method element of attaching a second split tubular section comprises welding a second split tubular section to the first split tubular section.

17. The method of claim 13 wherein the transducer communication component comprises a tube, and further comprising attaching the tube to the first split tubular section.

18. The method of claim 13 wherein the transducer communication component comprises thermocouple wiring, and further comprising attaching the thermocouple wiring to the first split tubular section.
